(19) United States
(12) Patent Application Publication
(10) Pub. No.: US 2008/0293854 A1
(43) Pub. Date: Nov. 27, 2008

(54) Plastisols Based on a Methylmethacrylate Copolymer

(75) Inventors: Jan Hendrik Schattka, Hanau (DE); Gerd Loehden, Hanau (DE); Winfried Belzner, Gruendau (DE)

Correspondence Address: OBLON, SPIVAK, MCCLELLAND MAIER & NEUSTADT, P.C., 1940 DUKE STREET, ALEXANDRIA, VA, 22314, US

(73) Assignee: ROEHM GMBH, Darmstadt (DE)

(21) Appl. No.: 11/571,115

(22) PCT Filed: Jun. 17, 2005
(86) PCT No.: PCT/EP2005/006538

§ 371 Date: Dec. 21, 2006

(30) Foreign Application Priority Data
Jun. 23, 2004 (DE) 10 2004 030 404.1

(51) Int. Cl. C08K 5/34

(52) U.S. Cl. 524/86

(57) ABSTRACT

The invention relates to plastisol systems with improved properties.

The invention relates to plastisol systems with improved mechanical properties together with improved storage stability.

Coatings and coverings composed of polyvinyl chloride (PVC) have long had an important role in the market, because they are versatile and have good service properties. Dispersions of PVC powders in plasticizers are knolls as plastisols and mostly have additions of stabilizers and, if appropriate, fillers and pigments, and are widely used for coating, in particular in the hot-dip coating process for example for corrosion protection of metals, for finishing of textiles and leathers, and for foams, adhesives and the like (cf. Sarvetnik, Plastisols and Organosols, Van Nostrand, New York 1972; W. Becker and D. Braun Kunststoff-Handbuch (Neuausgabe) [Plastics handbook (New edition)] Vol. 2/2, pp. 1077 et seq. Hanser Verlag 1086).

DE-A 26 54 071 discloses a process for production of coverings and adhesive bonds for materials based on PVC plastisols, characterized in that condensates prepared from:
A) a polymerized fatty acid mixture with an increased proportion of trimeric and more highly polymerized fatty acids (X) and from
B) an excess of polyalkylene polyamines,
   which has an imidazoline content (Y), are added in proportions of from 0.5 to 5% by weight, based on plastisol formulation, and are stoved at temperatures of or above 90° C., where, if one of the values of X or Y is less than the 40% limit the value of the other component should be at least 40+Z (where Z is the difference between the smaller value and 40), but preferably 40+2Z in order to achieve a significant effect.

DE-A 26 42 514 describes another version of the process according to DE-A 26 54 871. It uses as adhesion promoter,
A) Schiff bases having from 0.1 to 1.4 azomethine groups per 100 g of compound and/or
B) enamines having from 0.1 to 1.4 enamine groups per 100 g of compound,
   alone or in a mixture, in amounts of from 0.1 to 4.0 percent by weight, based on the PVC formulation, and also
C) from 20 to 80% by weight, based on the mixture of A, B and C, of epoxy resins.

In recent times there is a noticeable trend towards replacement of PVC by other materials. Reasons for this include environmental issues and the risk of dioxin formation in the event of a fire.

However, a factor applicable to all efforts in that direction has been the unwillingness of the industry to accept drastic cuts in the quality customarily associated with PVC products.

In some sectors, e.g. the coating of metals, plastisols based on poly(meth)acrylate has been successfully gaining a foothold (cf. DE-C 25 43 542, DE-C 31 39 090 or U.S. Pat. No. 4,558,084, DE-C 27 22 752, DE-C 24 54 235). U.S. Pat. No. 4,558,084 describes a plastisol based on a copolymer of methyl methacrylate and itaconic acid or itaconic anhydride, which is said to have adequate adhesion to electrophoretically pretreated metal surfaces. Other examples proposed are floorcoverings based on poly(meth)acrylate plastisols, in which straight polymethyl methacrylate (PMMA) is used, to some extent in the corm of emulsion polymer and to some extent in the form of suspension polymer (DE-C 39 03 669).

For the purposes of this application, the expression (meth)acrylic ester or (meth)acrylate can mean either methacrylic ester or methacrylate, e.g. methyl methacrylate, ethyl methacrylate, etc., or else acrylic ester or acrylate, e.g. methyl acrylate, ethyl acrylate, etc., or, if appropriates a mixture of the two.

An important application sector for plastisols is underbody protection from stone impact in motor vehicles. An essential precondition for this application is naturally high mechanical resistance to the resultant abrasion.

Another essential feature for processing in the automotive industry is maximum shelf life of the plastisol pastes.

EP 0533026 describes a plastisol system with improved adhesion to cataphoretic metal sheet, based on polyacrylic (meth)acrylates, where the gellable composition is composed of monomers having an alkyl substituent of from 2 to 12 carbon atoms and of the anhydride of an acid. Nothing is said about the abrasion resistance of the resultant plastisol formulations.

EP 1162217 describes a poly(meth)acrylate plastisol which is composed of primary particles with diameter>250 mm, where the primary particles are composed of core-shell particles. The resultant plastisols are storage-stable, but nothing is said about abrasion resistance.

Various patent specifications mention the possibility of using incorporation of nitrogen-containing monomers to improve adhesion which is (merely) one important precondition for good abrasion resistance but is certainly not equivalent thereto).

On the other hand, introduction of methacrylic acid in the shell is a familiar practice for improving the storage stability of plastisols.

However, simultaneous use of these monomers in a binder is often impossible if the result is formation of a salt between the basic nitrogen atom and the acid function.

It was an object to provide poly(meth)acrylate plastisols with excellent abrasion resistance together with improved stability of the plastisol pastes in storage.

The object has been achieved using plastisols based on a binder, characterized in that the binder comprises
a) from 0.2 to 15% by weight of a monomer which has a basic nitrogen atom and is capable of free-radical polymerization,
b) from 0.2 to 15% by weight of a simple or N-substituted amide of acrylic acid and/or of methacrylic acid, or of an amine-substituted alkyl ester of acrylic acid and/or of methacrylic acid,
c) from 0 to 0% by weight of one or more alkyl esters of methacrylic acid and/or of acrylic acid,
d) from 10 to 90% by weight of the methyl ester of methacrylic acid and
e) from 0 to 50% by weight of one or more monomers capable of copolymerization with the other monomers by a free-radical route,
where the entirety of the components is 100%, and at least one plasticizer and, if appropriate, adhesion promoters and, fillers and, if appropriate, other constituents conventional in plastisols are present.

Surprisingly, it has been found that the inventive plastisols based on a PMMA binder have very high abrasion resistances. The chipping resistance test (EP 1371674) is mostly carried out in practice to determine abrasion resistance. Abrasion resistances of over 70 kg of threaded nuts have been found to be achieved in this test.

These poly(meth)acrylate plastisols moreover have excellent adhesion to cataphoretically pretreated metal surfaces.

The binders for plastisols usually have latex particles with a core-shell structure.

The latex particles of the present application are composed of a core and of at least one shell, which are usually prepared in succession in two or more separate steps. The constitution of the core and of (each of the) shell(s) is generally different.

One component of the core is methyl methacrylate. The amount of this component present is preferably at least 20% by weight and at most 85% by weight. The proportion of methyl methacrylate can also preferably be from 30 to 70% by weight, or from 40 to 60% by weight.

The core of the latex particles usually comprises, as further component, one or more (meth)acrylic esters whose alcohol component contains from 1 to 8 carbon atoms or contains an aromatic radical.

In one particular embodiment, one component of the core of the latex particles is either n-butyl (meth)acrylate, isobutyl (meth)acrylate or tert-butyl (meth)acrylate or a mixture thereof.

The amount of these esters present may be from 15 to 80% by weight, from 30 to 70% by weight or from 40 to 60% by weight.

The cores of the latex particles may comprise, as further constituents, from 0 to 50% by weight, from 0 to 20% by weight, from 0 to 10% by weight, or from 0 to 5% by weight of one or more copolymerizable monomers. The presence of these monomers can be advantageous in particular instances in order, if appropriate, to establish, in a controlled manner, particular properties of the core of the latex particles. Use may be made of any of the ethylenically unsaturated compounds which can be incorporated, under the stated polymerization conditions, into the polymer which forms the core.

The abovementioned ethylenically unsaturated monomers may be used individually or in the form of mixtures.

The proportion by weight of each of the abovementioned components of the core of the latex particles may be varied within the stated ranges, but the total of the selected proportions of the components must always give a total of 100% by weight.

The latex particles comprise, as further component, at least one shell, these being formed on the core in a second or, if appropriate, further stage of the reaction. Physical forces alone, or else covalent bonds produced via grafting, can be used to secure the core to shell, or shells to one another.

When the term “shell(s)” is used here, this is intended to mean that the relevant statement can refer either to one shell or, if appropriate, to two or more shells present.

One component of the shell(s) is methyl methacrylate. The amount of this component present is preferably at least 20% by weight and at most 95% by weight. The proportion of methyl methacrylate can also preferably be from 40 to 85% by weight, or from 50 to 30% by weight.

The shell(s) of the latex particles usually comprise, as further component, one or more (meth)acrylic esters whose alcohol component contains from 1 to 8 carbon atoms or contains an aromatic radical.

One further component of the shell(s) is either an amide of acrylic acid and/or of methacrylic acid, or is an amine-substituted alkyl ester of acrylic acid and/or of methacrylic acid, or is a mixture composed of the above compounds.

Amides can be simple amides, i.e. acrylamide or methacrylamide, or N-substituted amides of acrylic acid and/or of methacrylic acid, bearing functional groups of the following formula

—C(O)—NR₁R₂

where R₁ and R₂, independently of one another, are H or are a linear or branched alkyl radical having from 1 to 10 carbon atoms, which may, if appropriate, also contain additional amino groups of the formula —NR₃R₄, where R₃ and R₄, independently of one another, are H or are a linear or branched alkyl radical having from 1 to 10 carbon atoms, or the nitrogen together with the substituents R₃ and R₄ may also form a five- to seven-membered ring. The ring may, if appropriate, also have substitution by one or more short-chain alkyl groups, such as methyl, ethyl or propyl, or may contain heteroatoms, such as nitrogen or oxygen.

The shells of the latex particles may comprise, as further constituent, from 0 to 50% by weight, from 0 to 20% by weight, from 0 to 10% by weight or from 0 to 5% by weight, of one or more copolymerizable monomers. The presence of these monomers can be advantageous in particular instances in order, if appropriate, to set, in a controlled manner, certain properties of the shell of the latex particles. Use may be made of any of the vinylenically unsaturated compounds which, under the stated polymerization conditions, can be incorporated into the polymer which forms the respective shell.

The abovementioned ethylenically unsaturated monomers may be used individually or in the form of mixtures. Examples of monomers which may be used having basic nitrogen (a) and capable of free-radical polymerization are N-vinyl-2-methylimidazole, N-vinyl-2-ethyl-imidazole, N-vinyl-2-phenylimidazole, N-vinyl-2,4-dimethylimidazole, N-vinylbenzimidazole, N-vinyl-imidazoline (also termed 1-vinylimidazoline), N-vinyl-2-methylimidazoline, N-vinyl-2-phenylimidazoline and 2-vinylimidazole, particularly preferably N-vinyl-imidazole (also termed 1-vinylimidazole).

Other suitable compounds are N-vinylpyrrolidone, N-vinyl-5-methylpyrrolidone, N-vinyl-3-methyl-pyrrol-done, N-vinyl-5-ethylpyrrolidone, N-vinyl-5,5-dimethylpyrrolidone, N-vinyl-5-phenylpyrrolidone, N-allylpyrrolidone, N-vinylthiopyrrolidone, N-vinyl-piperidone, N-vinyl-6,6-diethylpiperidone, N-vinyl-caprolactam, N-vinyl-7-methylcaprolactam, N-vinyl-7-ethylcaprolactam, N-vinyl-7,7-dimethylcaprolactam, N-allylcaprolactam, N-vinylcaprylolactam.

Other suitable monomers are N-vinylcarbazole, N-allylcarbazole, N-butenylcarbazole, N-hexenylcarbazole and N-(1-methylethylene)carbazole.

Examples of compounds which may be used as simple or N-substituted amides of acrylic acid and/or of methacylic acid or of an amine-substituted alkyl ester of acrylic acid and/or of methacrylic acid (b) are N-methyl(meth)acrylamide, N-dimethylaminoethyl(meth)-acrylamide, N-dimethylaminopropyl(meth)acrylamide, N-isopropyl(meth)acrylamide, N-tert-butyl-(meth)acryl-amide N-isobutyl(meth)acrylamide, N-decyl(meth)acryl-amide, N-cyclohexyl(meth)acrylamide, N-[3-(dimethyl-amino)-2,2-dimethylpropyl]methacrylamide, N-dodecyl-(meth)acrylamide, N-[3-dimethylaminopropyl](meth)-acrylamide, N-[2-hydroxyethyl](meth)acrylamide, and particularly preferably (meth)acrylamide.

Mention may also be made of the following amine-substituted alkyl esters of (meth)acrylic acid 2-dimethylaminoethyl (meth)acrylate, 2-d-ethylamino-ethyl (meth)acrylate, 3-dimethylamino-2,2-dimethyl-propyl 1-(meth)acrylate, 3-diethylamino-2,2-dimethyl-propyl 1-(meth)acrylate, 2-morpholinoethyl (meth)acrylate, 2-tert-butylaminoethyl (meth)acrylate, 3-(dimethylamino)propyl (meth)acrylate, 2-(dimethyl-aminoethoxyethyl) (meth)acrylate.

Compounds which may be used as alkyl esters of methacrylic acid and/or of acrylic acid (c) have the general formula

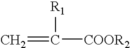

where R₁ is hydrogen or methyl
R₂ is an alkyl radical or cycloalkyl radical preferably having from 1 to 12, in particular from 1 to 8, carbon atoms, where these may, if appropriate, have branching, with the proviso that R₁ and R₂ are not simultaneously to be methyl. By way of example, mention may be made of n-butyl acrylate, n-butyl methacrylate, isobutyl methacrylate, tert-butyl methacrylate, 2-ethylhexyl methacrylate and cyclohexyl methacrylate.

Compounds (e) which may be used and are copolymerizable with the other monomers are, inter alia, 1-alkenes, such as 1-hexene, 1-heptene, branched alkenes, e.g. vinylcyclohexane, 3,3-dimethylpropene, 3-methyl-1-diisobutylene, 4-methyl-1-pentene, vinylesters, such as vinyl acetate, styrene and/or styrene derivatives, e.g. α-methylstyrene, α-ethylstyrene, vinyltoluene, p-methylstyrene.

It has been found that the amine-substituted alkyl esters of (meth)acrylic acid and the simple or N-substituted (meth)acrylamides compatible with the monomers a) contribute to stabilization of the shells with respect to plasticizer attack to the same extent as (meth)acrylic acid, which cannot be used.

The stabilization of the shell also gives the inventive plastisols good storage stability. The viscosity rise under standardized measurement conditions, a measure of storage stability, could be reduced below 16%.

In one particular embodiment, the core-shell polymer is composed of one core and of one shell. The ratio by weight of core to shell can be varied within wide limits and is from 10:90 to 90:10. This ratio by weight is calculated from the starting weight of the monomers.

Other embodiments can be core-shell polymers which are composed of one core and of two or more shells. The number of shells is in most instances 2 or 3, but can also be higher. The chemical constitution of individual shells or of all of the shells may be identical, or else, if appropriate involve different monomer constitutions.

The core-shell polymers of the present application are composed of latex particles whose primary particle size is at least 250 nm, preferably at least 500 nm and particularly preferably at least 700 nm. Primary particle size here means the diameter of an individual polymer particle which is generally approximately spherical and is non-agglomerated and which is obtained as product in the emulsion polymerization process. An average particle diameter is usually stated for his size and can, by way of example, be determined via laser scattering.

The binders may be prepared in a manner known per se, preferably via emulsion polymerization, which can, if appropriate, be carried out in two or more stages.

If emulsion polymerization is used, operation may advantageously be carried out by the emulsion process or monomer feed process, where a portion of the water and the entire amount or portions of the initiator and of the emulsifier form an initial charge. In these processes, particle size can advantageously be controlled via the amount of emulsifier forming an initial charge. Emulsifiers which may be used are especially anionic and non-ionic surfactants. The amount of emulsifier used is generally not more than 2.5% by weight, based on the polymer. Initiators which may be used, besides the compounds conventionally used in emulsion polymerization, e.g. per-compounds, such as hydrogen peroxide, ammonium peroxydisulphate (APS), are redox systems, such as sodium disulphite-APS-iron, and also water-soluble azo initiators. The amount of initiator is generally from 0.005 to 0.5% by weight, based on the polymer.

The polymerization temperature depends on the initiators, within certain limits. For example, if APS is used it is advantageous to operate in the range from 60 to 90° C. If redox systems are used it is also possible to polymerize at lower temperatures, for example at 30° C. Another process which may be used, besides feed polymerization, is the batch polymerization process. Here, the entire amount or a proportion of the monomers forms an initial charge with all of the auxiliaries, and the polymerization is initiated. The monomer-to-water ratio here has to be adapted to the amount of heat liberated in the reaction. Difficulties are generally avoided if a 50% strength emulsion is produced by first emulsifying half of the monomers and of the auxiliaries in the entire amount of water and then initiating the polymerization at room temperature and, once the reaction has taken place, cooling the mixture and adding the remaining half of the monomers with the auxiliaries.

The binders in solid form can be obtained in a conventional manner by freeze drying, precipitation, or preferably spray drying.

The spray drying of the dispersions may take place in a known manner. The industrial process uses what are known as spray towers, through which the dispersion is usually sprayed downwards in co-current with hot air. The dispersion is sprayed through one or many nozzles or preferably atomized by means of a perforated disc rotating at high speed. The hot input air has a temperature of from 100 to 250° C., preferably from 150 to 250° C. The exit temperature of the air has a decisive effect on the properties of the spray-dried emulsion polymer, this being the temperature at which the dried powder grains are separated from the air flow at the bottom of the spray tower or in a cyclone separator. This temperature is to be well below the temperature at which the emulsion polymer would sinter or melt. A very suitable exit temperature in many instances is from 50 to 90° C.

The exit temperature can be controlled at constant air flow rate via variation of the amount of dispersion sprayed continuously into the apparatus per unit of time.

The result here is mostly formation of secondary particles composed of agglomerated primary particles. It can sometimes be advantageous for the individual latex particles to adhesive-bond to one another to give larger units during drying (partial vitrification). A guideline value for the average grain sizes of the agglomerated units (measured, by way of example, by the laser scattering method) is from 5 to 250 μm.

The polymers to be used according to the invention may also be prepared by the suspension polymerization process.

The primary particle size in this case is usually in the range from 10 to 100 μm.

The inventive binders may also be prepared in the form of core-shell polymers by analogy with DE-C 27 22 752 or U.S. Pat. No. 4,199,486. The ratio by weight of core polymer to shell polymer here is preferably from 4:1 to 1:4. It is also possible to construct two or more shells around the core.

There is in principle a wide variety of monomers suitable for preparing the core-shell polymers.

The copolymers composed of a core material and of a shell material are constructed in a manner known per se via a certain procedure during emulsion polymerization. In this, the monomers forming the core material are polymerized in aqueous emulsion in the first stage of the process. Once the monomers of the first stage have substantially completed their polymerization, the monomeric constituents of the shell material are added to the emulsion polymer under conditions such as to avoid formation of new particles. The result is that the polymer produced in the second stage deposits in the form of a shell around the core material.

The inventive binders can be used to prepare plastisols which comprise core-shell polymers and comprise at least one plasticizer. Plasticizers are also often termed plastifying agents in many instances, use of a single plasticizer will suffice, but it can also be advantageous to use a mixture of two or more different plasticizers.

Plasticizers of which particular mention may be made are the phthalates, such as diisodecyl phthalate, diethylhexyl phthalate, diisononyl phthalate, di-C₇-C₁₁-n-alkyl phthalate, diioctyl phthalate, tricresyl phosphate, dibenzyltoluene, and benzyl octyl phthalate.

Other compounds, such as citrates, phosphates and benzoates, may also be used (cf. H. K. Felger, Kunststoff-Handbuch [Plastics handbook] Vol. 1/1C, Hanser-Verlag 1985, and also in H. F. Mark et al., Encyclopedia of Polymer Science and Engineering, Supplemental Volume pp. 568-647, J. Wiley 1989). A selection of suitable plasticizers can also be found in DE-C 25 43 542.

The plasticizers mentioned can also be used as mixtures.

The quantitative portions in plastisol pastes may vary within a wide range. In typical formulations the proportions of plasticizers are from 50 to 300 parts by weight for 100 parts by weight of the core-shell copolymer. Solvents (e.g. hydrocarbons) can also be used as diluents to meet rheological requirements—in particular during processing of the plastisols.

The plastisols also usually comprise amounts of from 0 to 300 parts by weight of inorganic fillers. By way of example, mention may be made of calcium carbonate (chalk) titanium dioxide, calcium oxide, and precipitated and coated chalks as additives with rheological action, and also, if appropriate, agents with thixotropic action, e.g. fumed silica.

Amounts of from 40 to 120 parts by weight of adhesion promoters are also often added to the plastisol; polyaminoamides or capped isocyanates are examples of those used. By way of example, EP 1371674 describes self-crosslinking capped isocyanates as particularly effective adhesion promoters for use in the poly(meth)acrylate plastisols sector. The plastisols may also comprise other constituents (auxiliaries) customarily used in plastisols, such as wetting agents, stabilizers, flow control agents, pigments, blowing agents, as required by the application.

By way of example, mention may be made of calcium stearate as flow control agent.

In principle, various types of mixer can be used to mix the components for the inventive plastisols. However, in agreement with the experience obtained with PVC plastisols and poly(meth)acrylate plastisols, preference is given to slow-running planetary mixers, high-speed mixers or dissolvers, horizontal turbomixers and three-roll mills; the selection here is influenced by the viscosity of the plastisols produced.

The plastisol composition can typically be gelled within less than 30 minutes at temperatures of from 100 to 220° C. (preferably from 120 to 160° C.) at layer thicknesses of from 0.05 to 5 mm.

A preferred application method for the coating of metal components is currently spraying processes, such as paste spraying processes. This plastisol process is usually carried out with high pressures (from about 300 to 400 bar) by way of airless spray guns.

In the particularly important application sector of automobile production and underbody protection, the usual procedure is that the plastisol is applied after electrodeposition painting of the bodywork and drying have been completed. Thermal curing usually takes place in a heated oven (e.g. oven with air circulation) for customary residence times—dependent on the temperature—in the range from 10 to 30 minutes, and at temperatures of from 100 to 2000′, preferably from 120 to 160° C.

Cataphoretic coating of metallic substrates has been widely described (cf. DE-A 27 51 498, DE-A 27 53 861, DE-A 27 32 736, DE-A 27 33 188, DE-A 28 33 786).

The inventive plastisols can be utilized for seam-covering. There are also fields of application in acoustic sound-deadening, e.g. in automotive construction.

Surprisingly, the inventive plastisol systems feature good to very good adhesion on metallic substrates, in particular on cataphoretic metal sheet.

The examples given below are intended to provide better illustration of the present invention, but do not restrict the invention to the features disclosed herein.

### EXAMPLES

### Inventive Example 1

1100 g of water form an initial charge under nitrogen in a 5 litre reactor temperature-controlled by means of a water bath and having a stirrer, reflux condenser, thermometer and feed pump. The system is preheated to 74-76° C., with stirring.

For initiation, 30 ml of a 5% strength aqueous solution of sodium peroxodisulphate and 30 ml of a 5% strength aqueous solution of sodium hydrogen sulphite are added. A monomer emulsion composed of 300 g of methyl methacrylate, 340 g of isobutyl methacrylate, 340 g of n-butyl methacrylate and 20 g of N-vinylimidazole is then added dropwise over the course of one hour, as also are 8 g of bis-2-ethylhexyl sulphosuccinate (sodium salt) and 450 ml of deionized water.

Once the materials have been metered in, the mixture is stirred for 30 min and then a further 15 ml of a 5% strength aqueous solution of sodium peroxodisulphate and 15 ml of a 5% strength aqueous solution of sodium hydrogen sulphite are then added. A second monomer emulsion composed of 880 g of methyl methacrylate, 50 g of isobutyl methacrylate, 50 g of n-butyl methacrylate, 20 g of N-vinylimidazole and 8 g of bis-2-ethylhexyl sulphosuccinate (sodium salt) and 450 ml of deionized water are then metered in within one hour. Water-bath cooling is used to prevent the reaction temperature rising above 80° C.

After addition of the emulsion, the temperature is held at from 75 to 80° C. during a post-reaction time of 30 min, before the resultant dispersion is cooled to room temperature.

### Inventive Example 2

The synthesis is analogous to Example 1. However, in the second monomer emulsion 30 g of methyl methacrylate are replaced by 30 g of methacrylamide.

### Comparative Example 1

EP 1162217 describes plastisols which are very representative of the prior art.

One example is the binder stated as Example A1, which comprises equal ratios by weight of core and shell. The core polymer is composed of 60% by weight of methyl methacrylate and 40% by weight of n-butyl methacrylate. The shell polymer contains 76% by weight of methyl methacrylate, 20% by weight of n-butyl methacrylate and 4% by weight of methacrylic acid.

The method of preparation is comparable to the process described in Inventive Examples 1 and 2.

### Inventive Example 3

The polymer dispersion is converted into a powder in a drying tower with centrifugal atomizer The tower exit temperature here is 80° C.; the rotation rate of the atomizer disc is 20 000 rpm.

### Inventive Example 4

The plastisols are prepared in a dissolver by analogy with the process set out in DIN 11468 for polyvinyl chloride pastes.

The following components were used:
100 parts by weight of binder
140 parts by weight of plasticizer (d-isononyl phthalate)
80 parts by weight of capped isocyanate (content of isocyanate groups 3.6%, average molar mass 3000 g/mol. Prepared via reaction of 6 parts by weight of toluene diisocyanate with one part by weight of polypropylene glycol (average molar mass 3000 g mol⁻¹) and subsequent capping of the isocyanate groups of the resultant urethane prepolymer with methyl ethyl ketoxime)
100 parts by weight of filler (calcium carbonate; Calcit GS0 from Kalkwerke Johann Schäfer)

### Inventive Example 5

The rise in viscosity over a defined period during defined storage is taken as a measure of storage stability.

For this, the viscosity V_{I} of the freshly prepared plastisol is measured.

The paste is then stored at 35° C. for 7 days in a sealed container. The viscosity V_{E} of the stored paste is then measured.

The rise in viscosity in percent is calculated as

(V_{E}−V_{I})/(V_{I})*100

• Viscosity rise is greater than 16%
◯ Viscosity rise is greater than 8% and smaller than 16%
* Viscosity rise is smaller than 8%

### Inventive Example 6

The plastisol paste is applied, using a doctor, at a thickness of 500 μm to a cathodically dip-coated metal sheet (KTL sheet).

The plastisol film then gels for 30 minutes at 140° C. in an electric oven.

### Inventive Example 7

Abrasion resistance is an excellent quality criterion for plastisols. A measurement method often used is described in EP 1371674. The chipping resistance test described there is based on a method in which the coating to be studied is applied with a defined layer thickness to a support mostly a metal sheet). Threaded nuts are then dropped onto the coating at a defined angle from a defined height. The quantity of threaded nuts that the coating withstands before the underlying material becomes exposed is utilized as a value to measure abrasion resistance

• Less than 40 kg
◯ More than 40 kg and less than 70 kg
* More than 70 kg

| | Binder from | Binder from | Binder from |
|---|---|---|---|
| | COMPARATIVE | INVENTIVE | INVENTIVE |
| | EXAMPLE 1 | EXAMPLE 1 | EXAMPLE 2 |
| Rise in viscosity of | ★ | ◯ | ★ |
| plastisol paste | | | |
| after 7 days | | | |
| (storage at 35° C.) | | | |
| Abrasion | ◯ | ★ | ★ |
| resistance (of a | | | |
| film produced | | | |
| according to | | | |
| Inventive | | | |
| Example 6) | | | |

The examples show that use of the nitrogen-containing monomer (vinylimidazole) significantly increases abrasion resistance.

However, sufficient storage stability can be achieved only in combination with methacrylamide.

1. Plastisol based on a binder, wherein the binder comprises
a) from 0.2 to 15% by weight of a monomer which contains a nitrogen heterocyle having a basic nitrogen atom and is capable of free-radical polymerization,
b) from 0.2 to 15% by weight of a simple or N-substituted amide of acrylic acid and/or of methacrylic acid, or of an amine-substituted alkyl ester of acrylic acid and/or of methacrylic acid,
c) from 0 to 80% by weight of one or more alkyl esters of methacrylic acid and/or of acrylic acid,
d) from 10 to 90% by weight of the methyl ester of methacrylic acid and
e) from 0 to 50% by weight of one or more monomers capable of copolymerization with the other monomers by a free-radical route,
where the entirety of the components is 100%, and at least one plasticizer and, if appropriate, adhesion promoters and/or fillers and, if appropriate, other constituents conventional in plastisols are present.

2. Plastisol based on a binder according to claim 1, wherein the monomer (a) having a basic nitrogen atom and capable of free-radical polymerization is N-vinylimidazole.

3. Plastisol based on a binder according to claim 1, wherein the amide (b) is methacrylamide.

4. Plastisol based on a binder according to claim 1, wherein the binder has a core-shell structure, where the monomer constitution of core and shell may be different.

5. Plastisol based on a binder according to claim 4, wherein two or more shells, if appropriate with different monomer constitutions, have been constructed around the core.

6. Plastisol based on a binder according to claim 1, wherein the abrasion resistance is above 50 kg of threaded nuts (chipping resistance test).

7. Plastisol based on a binder according to claim 1, wherein the abrasion resistance is above 70 kg of threaded nuts.

8. Process for preparation of plastisols based on a binder according to claim 1, wherein
a. the binder is prepared via emulsion polymerization, if appropriate in two or more stages,
b. the resultant dispersion is dried and
c. is then treated with at least one plasticizer and, if appropriate, with adhesion promoter and/or fillers and, if appropriate, other constituents conventional in plastisols.

9. Process for preparation of plastisols based on a binder according to claim 8, wherein, for preparation of the binder, an initiator solution forms an initial charge and a monomer emulsion is metered in, and, if appropriate, other monomer emulsions are metered into this monomer emulsion at temperatures of from 50 to 100° C.

10. Process for preparation of plastisols according to claim 8 wherein various monomer emulsions are metered in.

11. Process for preparation of plastisols according to claim 8, wherein the metering-in of the second and of each further monomer emulsion takes place at from 80 to 95° C.

12. Process for preparation of plastisols according to claim 8, wherein 100 parts by weight of binder are treated with from 50 to 300 parts by weight of plasticizer, from 40 to 120 parts by weight of adhesion promoter and or from 0 to 300 parts by weight of fillers.

13. Process for preparation of plastisols according to claim 8, wherein the dispersions are dried by means of spray drying.

14. A process for underbody protection of a motor vehicle comprising applying the plastisol according to claim 1 to the underbody of the motor vehicle.

15. A process for coating of a seam comprising applying the plastisol according to claim 1 to the seam.

16. A process for acoustic sound-deadening comprising applying plastisols according to claim 1 to at least one surface of the object to be acoustically sound-deadened.

17. The process of claim 14 wherein the motor vehicle is an automobile.

18. The process of claim 14 wherein applying the plastisol is carried out by a spraying process.

19. The process of claim 18 wherein the spraying process is a paste spraying process.

20. The process of claim 16 wherein the object to be acoustically sound-deadened is an automobile.
